(19) United States
(12) Patent Application Publication
(10) Pub. No.: US 2016/0117685 A1
(43) Pub. Date: Apr. 28, 2016

(54) A COUNTERFEITING CONTROL SYSTEM

(71) Applicant: INFO LABEL S.R.L., Carpi (Modena) (IT)

(72) Inventor: GIGLIO BASSI, CARPI (IT)

(21) Appl. No.: 14/892,403

(22) PCT Filed: May 21, 2014
(86) PCT No.: PCT/IB2014/061587

§ 371 Date: Nov. 19, 2015

(30) Foreign Application Priority Data
May 21, 2013 (IT) MI2013A000823
Sep. 25, 2013 (IT) MI2013A001584

(51) Int. Cl. G06Q 30/00; G06K 7/14; G06K 7/10

(52) U.S. Cl. CPC G06Q 30/0185; G06K 7/10712; G06K 7/10297; G06K 7/1417

(57) ABSTRACT

The invention discloses a counterfeiting control system for products intended for sale, comprising a product intended for sale (1) provided with a unique product code (ID), a first scanning device (100) for scanning this code, a first processing unit (200) associated with the scanning device (100), wherein the first processing unit (200) comprises a registration module (202) con figured to register, in a first memory module (203), the unique product code (ID) scanned by the first scanning device (100) if the device is authorized, a second scanning device (300), a second processing unit (40) associated with said second scanning device (300) and configured to assess the authenticity of said product intended for sale (1), and wherein the processing unit comprises a comparison module (401) configured to compare the scanned unique product code ID with registered codes representative of a saleable product and stored in the first memory module (203).

### TECHNICAL FIELD

The object of the present invention is a counterfeiting control system. Specifically, the object of the present invention is a counterfeiting control system for products intended for sale.

Even more specifically, the object of the present invention is a counterfeiting control system for garments, gadgets or similar products intended for sale.

### BACKGROUND ART

There are known counterfeiting control systems that operate within a framework of not allowing reproducibility of a label, a tag or an identification document.

With the digital computerized techniques currently in use, non-reproducibility is hardly possible to guarantee.

Therefore, the problem of guaranteeing reasonably secure counterfeiting control remains unsolved.

The aim of the present invention is to realize a counterfeiting control system that solves the above-mentioned problem, overcoming the drawbacks of the prior art.

Another aim of the present invention is to realize a counterfeiting control system that is easily approachable in terms of management and use.

### SUMMARY OF THE INVENTION

These and other aims are achieved by the counterfeiting control system as disclosed in the appended claims.

The invention, as disclosed, achieves the following technical effects:
Simple enabling of product code/label management;
Simple enabling of product distribution management via the Web (websites, PCs, smartphones and the like);
Code/label scanning by the end user for counterfeiting checks;
Provision of customized labels;

In other words, the invention intends to realize a system that can be used by companies of products intended for sale, particularly of garments and gadgets, more particularly pharmaceutical/food gadgets. For example, these products intended for sale may consist of eyeglasses, spare parts for automobiles, agri-food product packages, etc.

The system comprises the provision of customized codes on customized labels and/or other backings, such as holograms, the enabling of the management thereof and sales management via a website or applications for smartphones and windows PCs, in addition to management of product identification code scanning by the end customer so as to assess the authenticity of products.

The technical effects cited above and other technical effects of the invention will emerge in further detail in the description herein below of an embodiment provided as a non-limiting, indicative example with reference to the attached drawings.

### BRIEF DESCRIPTION OF THE DRAWINGS

FIG. 1 is a block diagram of the system of the invention.

FIG. 2 is a flow chart of the procedures that can be carried out by a first user of the system of FIG. 1.

FIG. 3 is a flow chart of the procedures that can be carried out by a second user of the system of FIG. 1.

FIG. 4 is a flow chart of the procedures that can be carried out by a third user of the system of FIG. 1.

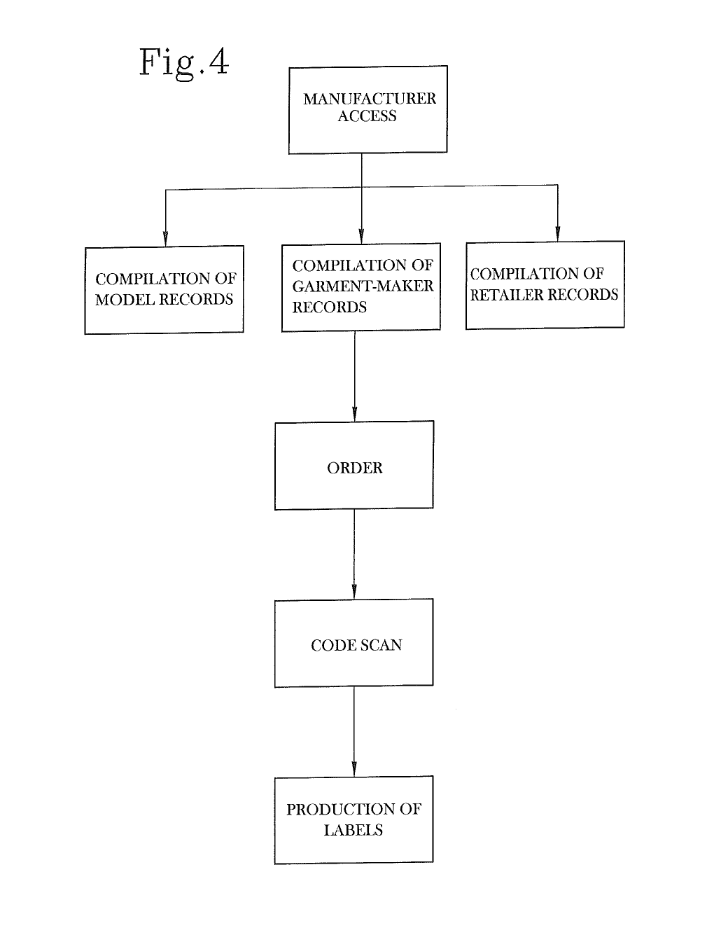

FIG. 5 is an outline of a network comprising the system of FIG. 1.

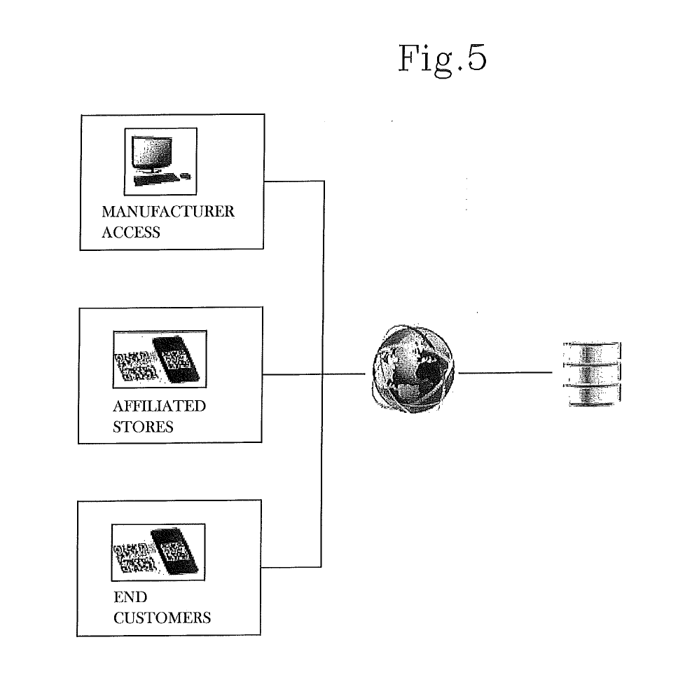

FIGS. 6-8 represent characteristics of a machine for mass-production application of images.

FIG. 9 schematically illustrates a unique product code realized with a QR code.

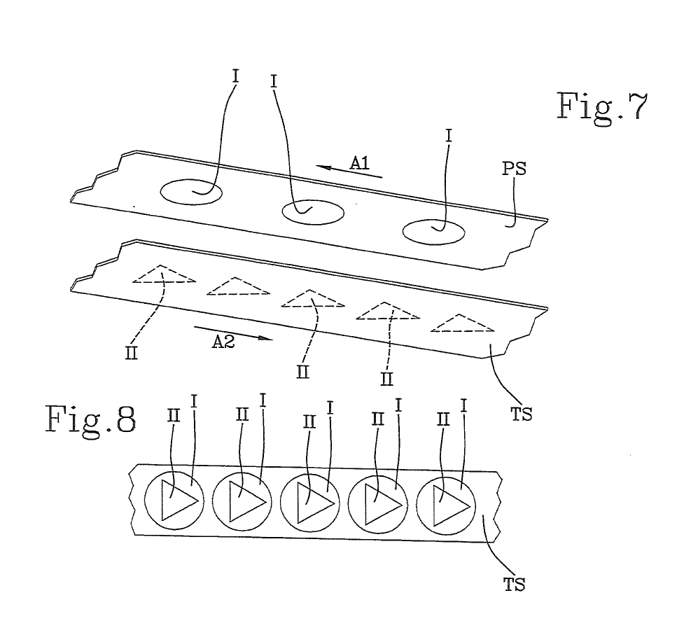

FIGS. 10A-10B schematically illustrate the unique product code comprised in an RFID tag.

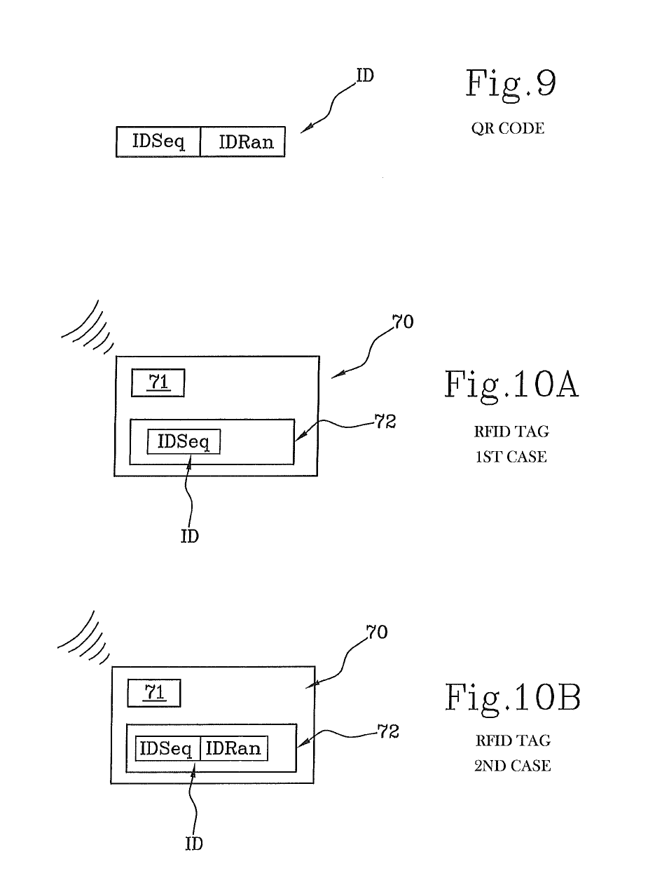

### DETAILED DESCRIPTION

The invention discloses a counterfeiting control system for products intended for sale, comprising a product intended for sale 1 provided with a unique product code, a first scanning device 100 for scanning this code, a first processing unit 200 associated with the scanning device 100, wherein the first processing unit 200 comprises a registration module 202 configured to register, in a first memory module 203, the unique product code ID scanned by the first scanning device 100 if the device is authorized, a second scanning device 300, a second processing unit 40 associated with said second scanning device 300 and configured to assess the authenticity of said product intended for sale 1, and wherein the processing unit comprises a comparison module 401 configured to compare the scanned unique product code ID with registered codes representative of a saleable product and stored in the first memory module 203.

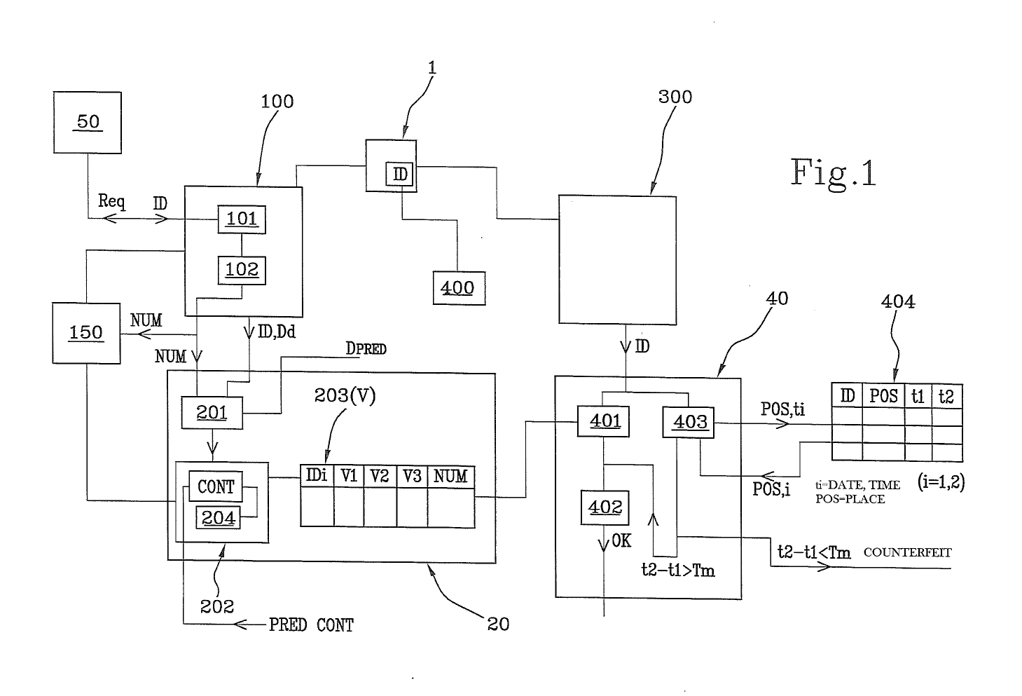

Referring particularly to FIG. 1, the counterfeiting control system for products intended for sale according to the invention, comprises a product intended for sale 1 that is provided with a unique product code ID.

Preferably, the unique product code ID appears on a backing coated with a solution that blocks visibility of the code.

The code can be made visible by removing this solution, for example in the manner known to be used for so-called “scratch cards”, that is, by scratching it with a rough object.

The unique product code ID preferably comprises a sequential component IDSeq.

This sequential component IDSeq preferably comprises a sequence of characters that are assigned in such a manner that different products have different IDSeq components assigned in a pre-established order, which may for example be in increasing numerical or lexicographic order.

In particular, the sequential component IDSeq can also be used in the label production process so as to keep track of the sequence for the realization of the label.

Alternatively, the unique product code ID comprises a concatenation of the sequential component IDseq and a random component IDRan.

In particular, the random component IDRan is generated by a suitable known algorithm.

Advantageously, the randomness of the code prevents a potential counterfeiter from foreseeing the next valid code to be reproduced. The product intended for sale 1 preferably comprises a garment or a gadget, particularly relating to the pharmaceutical/food sector, for example eyeglasses, spare parts for automobiles, agri-food product packages, etc., and the corresponding unique product code ID comprises a QR label.

The QR label preferably comprises a QR code, which is determined by the concatenation of the sequential component IDSeq and the random component IDRan.

In one embodiment, with reference to the food sector for example, the QR code can comprise data concerning the physical characteristics of the product.

In particular, these data can refer for example to the weight, height and capacity of the product to be sold, or to other units of measurement referring to the characteristics of the product.

Preferably, the QR label can be coloured so as to be distinguishable based on its use.

For example, the colour of the QR label can be conventionally black and white for marketing purposes, red for counterfeiting control purposes, blue for tracking information and green to indicate all of the above together.

This QR label is preferably made of fabric.

Alternatively, this label is indelibly printed on fabric.

In particular, the indelible printing is realized by means of a machine 150 for the mass-production application of images, as described in patent application no. MI2012A000163 filed by TECNO LABEL srl.

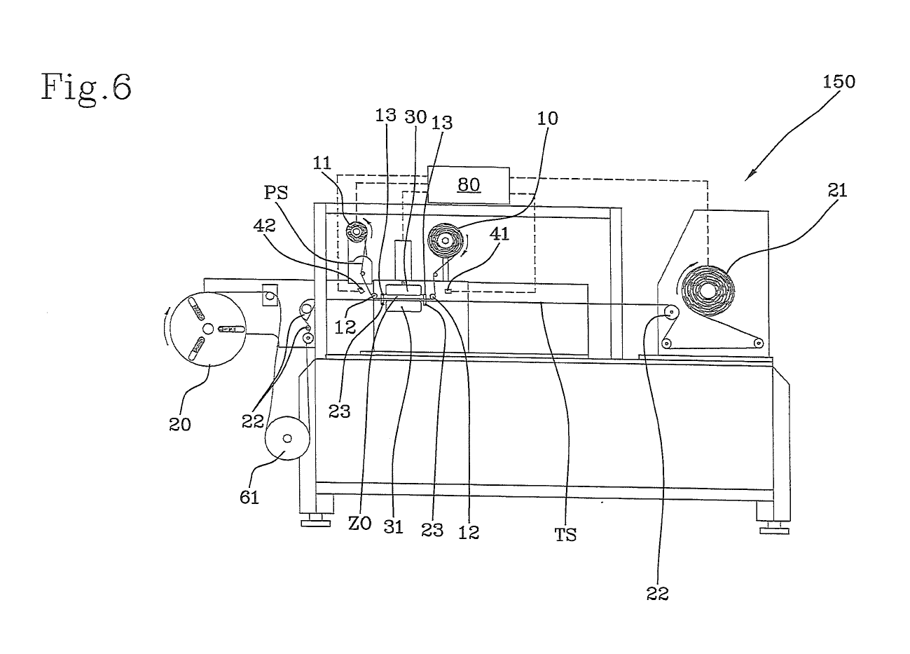

With reference to FIGS. 6 and 7, this machine comprises a first feed device 10, 11, 12, 13 for a first continuous backing PS bearing a series of images I.

The machine further comprises a second feed device 20, 21, 22, 23 for a second continuous backing TS bearing images, and arranged in such a manner that the second continuous backing TS bearing images transits in an operative zone ZO, where it faces the first continuous backing PS.

The machine further comprises (FIG. 6):
presser means 30, 31 predisposed to hot-press the first backing PS and the second backing TS at the operative zone ZO;
a control module 80 predisposed to control the activation of the first and the second feed device and the presser means.

The machine further comprises positioning means 41, 42 connected to the control module 80 and predisposed to detect the position of the first backing PS with respect to the operative zone ZO, detect the position of the second backing TS with respect to the operative zone ZO, bring about the stopping of the first and the second feed device at a centred position of the first and the second backing with respect to the operative zone, and bring about the activation of the presser means 30, 31 following detection of said centred position of the first and the second backing with respect to the operative zone.

Alternatively, the product intended for sale 1 comprises a gadget and the corresponding unique product code ID comprises a QR label.

This QR label is preferably realized by means of digital printing.

This QR label preferably comprises a hologram.

Advantageously, according to the invention, the QR label is dyed in the hologram by means of the machine 150 described hereinabove, preferably by means of a sublimation method, as shown particularly in patent application no. MI2012A000163 filed by TECNO LABEL srl.

As an alternative or in addition to the QR code, the unique product code ID is comprised in an RFID tag 70.

In a preferred embodiment, the RFID tag 70 comprises a processing module 71 configured for management of the functions of the tag and a memory module 72 configured to contain the unique product code ID.

According to the invention, the memory module 72 is initially virgin and configurable by means of registration of the unique product code ID associated with the product intended for sale.

In other words, the memory module 72 is writable with the unique product code ID associated with the product intended for sale.

According to the invention, the unique product code ID associated with the product intended for sale and registered in the memory module 72, consists of the QR code assigned to the product intended for sale.

The product intended for sale that can be associated with the RFID tag 70 can consist of any product provided for association with the previously described QR code.

Preferably, the unique product code ID that is writable in the memory module 72 comprises the sequential component IDSeq.

Alternatively, the unique product code ID that is writable in the memory module 72 comprises a concatenation of the sequential component IDSeq and the random component IDRan of the unique product code ID.

In one embodiment, for example with reference to the food sector, the RFID tag can comprise data concerning the physical characteristics of the product.

In particular, such data can refer, for example, to the weight, height and capacity of the product to be sold, or to other units of measurement referring to the characteristics of the product. The system further comprises a first scanning device 100 configured to scan the unique product code ID.

According to the invention, this first scanning device is a smartphone or a PC or similar devices equipped with software capable of scanning the unique product code ID.

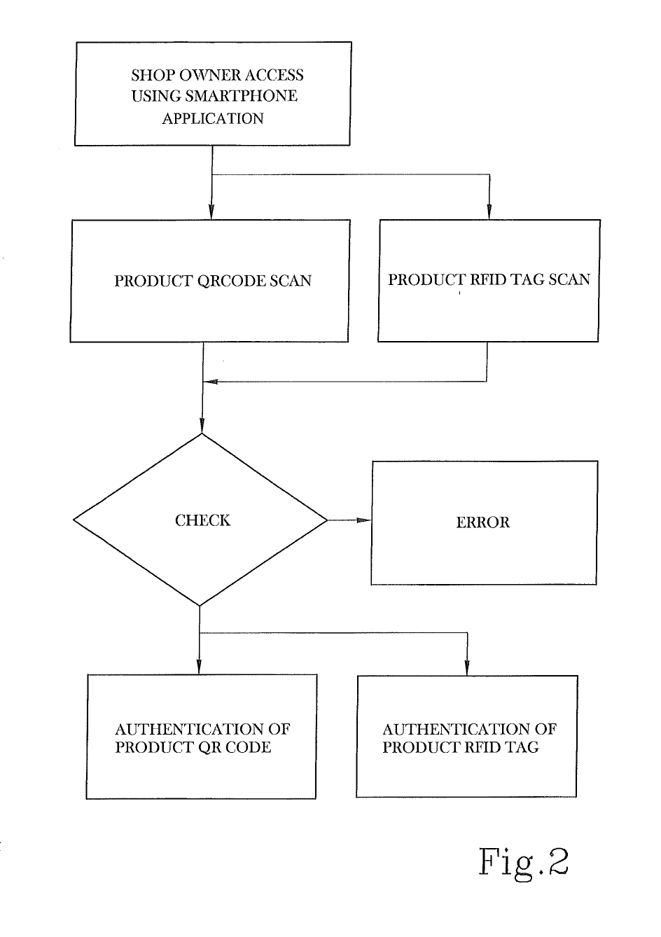

Advantageously, according to the invention, the first scanning device 100 is in use at a business in charge of selling the product intended for sale 1. In other words, with reference to FIG. 2, the user accessing as a business, that is, the vendor (previously authorized by the firm), performs the task of registering the products he/she is selling, thereby activating the codes.

The businesses must supply themselves with the instruments for the registration process, preferably a smartphone provided with the Android or Apple iOS operating system, a camera and an Internet data connection and the specific app, which is supplied free of charge, needs to be downloaded and installed.

This app makes it possible to enter and store the username and password of the shop owner, and to scan the QR code on the label using the camera; in this manner, registration takes place for sale of the product. The data transmitted in an encrypted form include the username and password of the shop owner (stored in the smartphone application), and the product code+random code (obtained from the QR code).

In one embodiment, the QR code and/or RFID tag can comprise data concerning the physical characteristics of the product.

The system will check the credentials of the shop and check whether the product code+random code is present in the archive, and that the status thereof is not an unauthenticated state; at this point the product can be authenticated and the name of the authorized shop is associated with that product so that it can be traced back to the point of sale in subsequent scans.

In particular, the system can also later assess whether the data concerning the physical characteristics of the product vary over time; for example in the food sector, if the product is represented by a weighable element (e.g. a prosciutto ham), the system can evaluate weights of the prosciutto at subsequent times in order to ensure that an amount of the identified product exceeding the available amount is not sold.

In other words, in the case of sales, for example of prosciutto ham, each time a part of this prosciutto is sold by weight, that part will be identified by a corresponding unique identifier (QR code or RFID tag), in which the weight of the product sold will be stored, enabling the system to calculate the weight of the remaining product.

Advantageously, according to the invention, this ensures that a product of lesser quality is not sold using an identifier of a product of superior quality. In fact, the system is capable of understanding when the product has sold-out and the product code is no longer usable.

More specifically, the above procedures referring to the procedures carried out by a business are realized using the first scanning device 100 and a first processing unit 200.

In general, it should be noted that in this description and in the appended claims, the processing units are presented as units subdivided in separate functional modules (memory modules or operative modules) for the sole purpose of describing the functions of these units clearly and completely.

These processing units may actually be constituted by a single electronic device (or board) suitably programmed to perform the described functions, and the various modules can consist of hardware entities and/or routine software that are part of the programmed device.

Alternatively or additionally, these functions can be performed by a plurality of electronic devices on which the above-mentioned functional modules can be distributed.

The processing units can also use one or more processors for execution of the instructions contained in the memory modules.

According to the invention, the first scanning device 100 is configured to transmit the scanned unique product code ID to the first processing unit 200.

In one embodiment, this unique product code ID, namely the QR code or RFID tag, can comprise data concerning the physical characteristics of the product.

For example, if the product is a food product (e.g. a prosciutto ham), the first scanning device 100 will also read the initial weight of the product.

The first scanning device 100 is further configured to transmit its own identification data Dd to the first processing unit 200, together with the scanned unique product code ID.

According to the invention, the first processing unit 200, which is associated with said scanning device 100, comprises a control module 201 configured to check the identification data Dd of the scanning device 100.

The control module 201 is configured to compare the data Dd with predefined data Dpred of authorized scanning devices 100.

In other words, the control module 201 checks whether the business that has scanned the unique product code is authorized to do so and not a counterfeiter attempting to activate products fraudulently for the sale thereof.

The control module 201 is further configured to authorize processing of the scanned unique product code ID if the device 100 proves to be authorized. According to the invention, the first processing unit 200 further comprises a registration module 202 that is configured to register the scanned unique product code ID in a first memory module 203 if the device proves to be authorized.

The registration module is further configured to assign values V1, V2, V3 representative of a saleable product V to the scanned unique product code ID.

The registration module is further configured to store the values V1, V2, V3 representative of a saleable product V in the first memory module 203, together with the respective scanned unique product code ID.

According to the invention, the values representative of the saleable product V comprise:
a first value V1 representative of a registered product;
a second value V2 representative of an unsold product;
a third value V3 representative of a saleable product that has not sold-out.

In one embodiment, V1 can be representative of a food product, for example a prosciutto ham, as described above, and contain data on this product such as the weight thereof for example.

As the product is gradually sold by a business, the system records the new weight of the product.

In other words, the first value, V1, will remain unchanged, whereas the third value, V3, will change based on the weight of the sold product.

In other words, in one embodiment of the invention, the third value, V3, is suitable for changing based on a measurable physical characteristic of the product, particularly based on a decrease in a value representing the availability of this product. In the case of the above-mentioned prosciutto ham, this value representing the availability of the product consists of the weight thereof.

According to the invention, the registration module 202 advantageously further comprises a counter Cont representative of a possible number of identical product codes for a set of products 1 intended for sale.

In one embodiment, the counter Cont can contain a value representing the availability of a product, for example the weight thereof.

Consequently, the registration module 202 comprises a calculation module 204 configured to advance said counter Cont with each scan on the part of said second scanning device 300.

The system according to the invention comprises a second scanning device 300 configured to scan the unique product code ID on the product intended for sale 1.

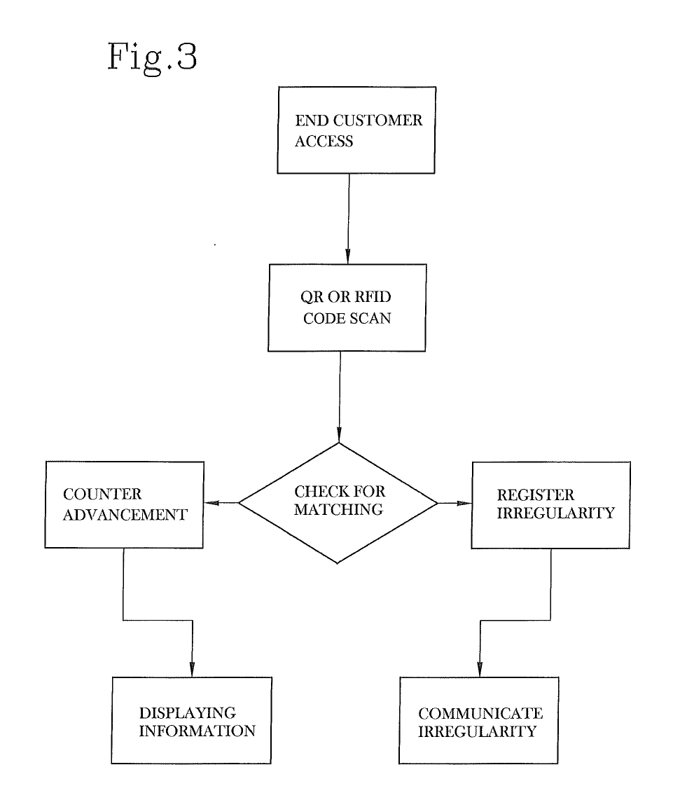

The second scanning device 300 is the customer-side device used by the customer to request information about the product to be purchased and about its authenticity; A general block diagram of the customer-side procedures appears in FIG. 3.

Registration in the system is not necessary for the end Customer, who can, however, scan the QR code or the RFID without having to download any specific application in order to check the registration status of a particular product. In other words, information about the product can be displayed using any app that is capable of scanning a QR code or an RFID.

The information displayed and display modes can be chosen by the manufacturing firm.

The data displayed principally include data on the authenticity of the product, on the number of scans performed on the specific label and on a possible excess of scans.

In particular, with reference to the procedures performed by the customer, the above-mentioned processes are performed by means of the second scanning device 300 and a second processing unit 40 associated with this second scanning device 300.

The second scanning device 300 is also configured for connection with the first processing unit 200.

According to the invention, the second processing unit 40 associated with the second scanning device 300 is advantageously configured to assess the authenticity of the product intended for sale 1.

According to the invention, the second processing unit 40 comprises a comparison module 401 configured to compare the scanned unique product code ID with the registered codes representative of a saleable product V and stored in the first memory module 203.

The processing unit further comprises a confirmation module 402 configured to send to the second scanning device 300 an authenticity confirmation signal OK based on a positive result of the comparison carried out by the comparison module 401.

In particular, the second processing unit 40 comprises a confirmation module 402 configured to generate the confirmation signal OK confirming the authenticity of the product intended for sale.

The confirmation module 402 is configured to generate this signal based on the verification of the registered product value V1 and the unsold product value V2.

Moreover, should the third value V3 be representative of a saleable product that has not sold-out, the confirmation module 402 is configured to generate the confirmation signal (OK) confirming the authenticity of the product intended for sale 1 based on verification of the third value V3 being lower than a predetermined value Pred_cont of the counter Cont. In one embodiment, the Pred_cont value of the counter Cont contains a value representing the remaining availability of a product, for example the weight thereof, as obtained based on its initial availability and the amount of the product sold.

To sum up, the system of the invention realizes a counterfeiting control based on the tracking of products by means of the application of a label with a unique product code for each product, said unique product code being traceable by means of an online database.

The system guarantees the quality of the product by preventing the sale of a product that has an identification code differing from the original code, thereby preventing for example that a product of lesser quality is sold passing it off as a product of superior quality.

In other words, the labelling is linked to a computerized online database that enables counterfeiting control that can be configured at a number of levels and data collection for the purposes of tracking, statistical use and advertising.

The system advantageously assumes that a label can always be reproduced, but this does not mean it will make reproduction an easy thing to do.

In fact, in addition to offering simple tools for informing customers as much as possible so as to make them capable of recognizing a counterfeit garment on their own, this type of system is devised for integration with several measures such as the use of special threads or yarns, watermarks, holograms and other techniques, although such elements remain supplementary to the basic system.

Other systems based on online archives and that check multiple registrations fail if not all clients register (which for that matter is highly possible). This process may, however, also be integrated in the system in the future.

The task of online registration has been assigned to a reliable intermediary, who in this case is the shop owner, in order to ensure a high level of efficiency of the system. This allows for reasonable certainty of registration, which is the basic prerequisite from which to start.

The most important technical effect achieved is that if a counterfeiter tries to reproduce the product without this label, or with a label bearing a QR code or an RFID that connects to a site differing from the original site, falsifying the response, the customer is informed that the garment is not authentic.

Moreover, if a counterfeiter attempts to reproduce the label starting from an existing label and repeating it as is, when the end customer scans it by means of a QR code scanner with an Internet connection (which is now available with almost all smartphones), he/she is directed to the garment description page, where how to recognize whether the garment is authentic (e.g. if holograms, special threads or yarns or other elements should be present) is explained in detail and more importantly, the shop owner's registration status is also indicated.

If the customer has not yet purchased the product, he/she should expect it to prove to be unregistered—otherwise, the product proves to be counterfeit, as in fact, it means that an authorized shop owner had previously registered the authentic product.

On the contrary, once the purchase has been made and registration completed, the customer should expect the scan to indicate also the place and date of purchase of the product, both corresponding to the customer's own information. If this takes place, the customer can be certain as to the authenticity of the product.

The manufacturer of the product 1 that will be intended for sale is another figure involved in the system.

The system according to the invention comprises a writing device 400 configured to enter the descriptive data about the product 1 for each product to be labelled; the descriptive data will be supplied to the end customer when he/she scans the QR code or the RFID by means of the second scanning device 300.

This writing device 400 is used by the manufacturer of the products intended for sale 1.

The writing device 400 is further configured to allow the manufacturer to decide whether to use the counterfeiting control system of the invention. The writing device 400 is also configured to enable the manufacturer to inform the system if the product will be mass-produced and thus provided with the same QR code associated with the previously described counter Cont.

Alternatively, the writing device 400 is further configured to enable the manufacturer to inform the system if the labels produced must indicate a unique serial number ID for each product 1 intended for sale.

In other words, the writing device 400 makes it possible to inform the system if, for a specific product that must be attributed to a particular garment-assembler (mass-production garment manufacturer), one wishes to use the counterfeiting control system (product certification by the authorized retailer) or if the labels produced must indicate a unique serial number for each garment.

If the counterfeiting control system is used, the manufacturer must indicate the information regarding the authorized sellers who will be using the app for authentication of the QR code.

If the product must be attributed to a garment-assembler, a table of garment-assemblers must be completed with their personal data.

Lastly, one can proceed with the order, indicating, for each product, the number of labels to be produced and if use of the counterfeiting control system is needed for that product.

The product codes 1 generated are collected in a table and can principally be of two types:

Simple Qrcode: QR codes that will be produced in N pieces, but they will all be identical and cannot be used for counterfeiting control, but only for informative and marketing purposes.

Unique QRcode (indicated as ID in this description): these QR codes are made up of an id_product number assigned sequentially by the system and a random code that makes them suitable for the counterfeiting control system.

When the second scanning device 300 reads the content of the QR code, it is interpreted as a web link for connection to a dedicated server and in the link queue, and the parameters needed to specify the product information will be passed by means of the GET method of the HTTP protocol.

According to the invention, the information on the product includes:

CodCapo: auto-increment garment code

This identifies an individual garment in the system; it can also be used in the label production process so as to keep track of the sequence for the realization thereof, and in the event that labels are lost, the lost labels can be identified and recovered.

CodRan: associated random code

This too is a unique code identifying an individual garment, but it is not sequential, so that a counterfeiter cannot predict the next valid code for reproduction.

By means of the information on the label, each garment can be univocally identified, the data in the archive can be checked to ensure that they match and the customer can be supplied with information.

According to the invention, the processing unit 40 advantageously comprises a localization module 403.

The localization module 403 is configured to localize the second scanning device 300 based on a completed scan of said unique product code ID, thereby determining a current position POS of the scanning device 300.

In other words, the localization module 403 enables localization of the user who is scanning the unique product code ID, and as a result it also enables localization of the product intended for sale 1.

The localization module 403 is further configured to assign a time stamp ti (i=1 . . . n with i=number of times the unique product code ID is scanned) upon subsequent scans of the same unique product code ID for each time the current position POS is determined.

In other words, when the product code is scanned by a customer, the system stores the current date and time in the memory.

The localization module 403 is further configured to store the scanned unique product code ID, the corresponding detected position POS and the assigned time stamp t1 in a memory module 404.

The localization module 403 is further configured to compare said unique product code ID with previously stored unique product codes ID.

In the case in which there are two stored unique product codes ID that match, the localization module is configured to compare the corresponding positions POSi (1=1 . . . n=consecutive number of the scan of the same unique product code ID).

In the case of different positions POSi, the localization module is configured to calculate the distance between the two subsequent positions POSi and the average travel time Tm between the two positions POSi.

The localization module 403 is configured to compare the time stamps (ti with i=1, 2) of the positions POSi corresponding to the same unique product code ID; if the interval of time between one scan of the unique product code (at time t2) and a previous scan of the same code (at time t1) is shorter than the time required to move from position Pos2 (corresponding to the scan at time t2) to position Pos1 (corresponding to time t1), apart from the tolerances predefined upon configuration of the system, then the product is held to be counterfeit; otherwise the product intended for sale 1 is considered to be authentic.

In summary,
if t2−t1<Tm, then the product is considered to be counterfeit;
if t2−t1>Tm, then the product is considered to be authentic.

The formulas provided above are valid also based on a predefined tolerance calculated as a percentage of time tp, for example ±20% of the calculated time Tm, to enable reasonable accuracy of the calculation. The technical effect achieved consists of the detection of the counterfeiting of a product intended for sale 1 also based on the localization thereof.

In a second embodiment of the invention, the retailer or third party, or garment-assembler can print, on their own, the unique product codes ID previously purchased from the manufacturer of unique product codes.

In other words, in the second embodiment of the invention, the system comprises a production station 50 for producing unique product codes ID.

In this embodiment, the first scanning device 100, which can be on the seller side or garment-assembler side or third-party side, comprises an acquisition module 101 configured to transmit a request Req for a unique product code ID to the production station 50 and to receive this code ID, the code being intended to be associated with the product intended for sale 1.

The scanning device 100 further comprises a transmission module 102 configured to transmit a total numerical value NUM of products intended for sale 1 that will be identified using the same unique product code ID.

The processing unit 200 comprises the previously cited registration module 202, which is further configured to register said total numerical value NUM in the first memory module 203, having received this total numerical value NUM from the transmission module 102.

Advantageously, according to the invention, the first scanning device 100 is associated with a printer or a writing device (e.g. laser) or similar devices 150 for printing/writing unique product codes ID to be associated with the products intended for sale 1, based on the total numerical value NUM of products intended for sale 1 that will be identified by the same unique product code ID.

In other words, the retailer or garment-assembler or third party that has purchased a predefined number NUM of identification codes ID to be assigned to their products intended for sale 1, uses a dedicated printer or writing device (e.g. laser device), which, in contact with the processing unit 200, is controlled by the registration module 202 for the number of unique product codes ID so that they cannot print more codes than the number allowed.

The achieved technical effect consists in the independence of the retailer or third party, or the garment-assembler, for printing, without relinquishing the guarantee of counterfeiting control over products being sold.

The invention also comprises a counterfeiting control method for controlling products intended for sale that is implemented using the counterfeiting control system described hereinabove.

The method essentially comprises the steps of preparing a product intended for sale 1 provided with a unique product code ID, preparing a first scanning device 100, preparing a first processing unit 200 associated with the scanning device 100, preparing a second scanning device 300 and preparing a second processing unit 40 associated with the second scanning device 300 and configured to assess the authenticity of the product intended for sale 1.

According to the invention, the first scanning device 100 is configured to implement the steps of
scanning the unique product code ID;
transmitting the scanned unique product code ID;
transmitting identification data Dd identifying the scanning device 100, together with the scanned unique product code.

According to the invention, the first processing unit 200 is associated with the first scanning device 100 and configured to implement the following steps by means of a control module 201:
controlling the identification data Dd identifying the scanning device 100;
comparing the data Dd with predefined data Dpred of authorized scanning devices 100;
authorizing the processing of the scanned unique product code ID if the device 100 proves to be authorized.

According to the invention, the first processing unit 200 is further configured to implement the following steps by means of a registration module 202:
registering, in a first memory module 203, the unique product code ID scanned by the first scanning device 100 if the device is authorized;
assigning values V1, V2 representative of a saleable product V to the scanned unique product code ID;
storing the values V1, V2, V3 representative of a saleable product V in the first memory module 203, together with the respective unique product code ID.

According to the invention, the second scanning device 300 is configured to implement the steps of:
scanning the unique product code ID on the product intended for sale 1;
connecting with the first processing unit 200.

According to the invention, the second processing unit 40 is associated with the second scanning device 300 and configured to implement the following steps, by means of a comparison module 401:
comparing the scanned unique product code ID with said registered codes representative of a saleable product and stored in said first memory module 203.

According to the invention, the second processing unit 40 is further configured to implement the following steps by means of a confirmation module 402:
sending to the second scanning device 300 an authenticity confirmation signal OK based on a positive result of the comparison carried out by the comparison module 401.

The method is preferably characterized in that it is implemented by a computer.

The method further comprises steps corresponding to the functions of the described operative units and modules making up the system of the invention.

The invention further comprises a computer program, which, when executed, implements the steps of the method of the invention.

1. A counterfeiting control system for products intended for sale, comprising:
a product intended for sale provided with a unique product code;
a first scanning device configured to:
scan said unique product code;
transmit said scanned unique product code;
transmit identification data identifying said scanning device, together with said scanned unique product code;
a first processing unit, associated with said scanning device, said first processing unit comprising:
a control module configured to:
control said identification data identifying said scanning device;
compare said data with predefined data of authorized scanning devices;
authorize the processing of said scanned unique product code if said device proves to be authorized
a registration module configured to:
register, in a first memory module, said unique product code scanned by said first scanning device if said device is authorized;
assign values representative of a saleable product to said scanned unique product code;
store said values representative of a saleable product in said first memory module, together with the respective unique product code;
a second scanning device configured to:
scan said unique product code on a product intended for sale;
connect with said first processing unit;
a second processing unit, associated with said second scanning device and configured to assess the authenticity of said product intended for sale, the processing unit comprising:
a comparison module configured to compare said scanned unique product code with said registered codes representative of a saleable product and stored in said first memory module;
a confirmation module configured to send to said second scanning device an authenticity confirmation signal based on a positive result of the comparison carried out by said comparison module.

2. The system according to claim 1, wherein said values representative of said saleable product comprise:
a first value representative of a registered product;
a second value representative of an unsold product and said confirmation module is configured to generate said confirmation signal confirming the authenticity of said product intended for sale based on the verification of said registered product value and said unsold product value.

3. The system according to claim 1, wherein said registration module comprises a counter representative of a possible number of identical product codes for a set of products intended for sale.

4. The system according to claim 3, wherein said registration module comprises a calculation module configured to advance said counter with each scan on the part of said second scanning device.

5. The system according to claim 1, wherein said second processing unit comprises a localization module configured to:
localize said second scanning device as a function of a completed scan of said unique product code, thereby determining a current position of said scanning device;
assign a time stamp to subsequent scans of the same unique product code for each subsequent current position determined;
store in a memory module, said scanned unique product code, said corresponding position detected and said time stamp assigned.

6. The system according to claim 5, wherein said localization module is further configured to:
compare said unique product code with previously stored unique product codes;
in the event that two stored unique product codes match, compare the corresponding positions;
in the event of different positions, calculate the distance between two consecutive positions and the average travel time between the two positions;
compare the time stamps (ti with i=1,2) of the positions corresponding to the same unique product code;
if t2−t1<tm, then the product is considered to be counterfeit;
if t2−t1>tm, then the product is considered to be authentic.

7. The system according to claim 1, wherein said values representative of a saleable product comprise: a third value representative of a saleable product that has not sold-out and said confirmation module is configured to generate said confirmation signal confirming the authenticity of said product intended for sale based on the verification of said value being lower than a predetermined value of said counter.

8. The system according to claim 1, comprising a production station for producing unique product codes, and wherein said first scanning device comprises:
an acquisition module configured to transmit a request for a unique product code to said production station and to receive said code, said code being intended to be associated with said product intended for sale;
a transmission module configured to transmit a total numerical value of products intended for sale that will be identified with the same unique product code;
and said first processing unit comprises:
said registration module configured to register said total numerical value in said first memory module, having received said total numerical value from the transmission module.

9. The system according to claim 8, wherein said first scanning device is associated with one of the following: a printer, a writing device or similar device for writing unique product codes to be associated with said products intended for sale, as a function of said number of products intended for sale that will be identified with the same unique product code.

10. The system according to claim 8, wherein said unique product code comprises a QR label.

11. The system according to claim 10, wherein said unique product code comprises a concatenation of a sequential component and a random component.

12. The system according to claim 10, wherein said QR label is made of fabric.

13. The system according to claim 10, wherein said QR label is realized by means of digital printing.

14. The system according to claim 10, wherein said QR label comprises a hologram.

15. The system according to claim 1, wherein said unique product code is comprised in an RFID tag.

16. The system according to claim 15, wherein said RFID tag comprises a processing module configured for management of the functions of the tag and a memory module configured to contain said unique product code.

17. The system according to claim 16, wherein said memory module is initially virgin and configurable by means of registration of the unique product code associated with the product intended for sale.

18. The system according to claim 17, wherein said unique product code that is writable in the memory module comprises a sequential component.

19-20. (canceled)

21. The system according to claim 1, wherein said product intended for sale comprises one or more of either a garment or a gadget or similar items.

22. A counterfeiting control method for controlling products intended for sale that is implemented using the counterfeiting control system of claim 1, wherein the method comprises the steps of preparing:
a product intended for sale provided with a unique product code,
a first scanning device,
a first processing unit associated with the scanning device,
a second scanning device,
a second processing unit, associated with the second scanning device and configured to assess the authenticity of the product intended for sale,
wherein the method comprises the following steps implemented by the first scanning device:
scanning the unique product code;
transmitting the scanned unique product code;
transmitting identification data identifying the scanning device, together with said scanned unique product code;
wherein the method comprises the following steps implemented by the first processing unit by means of a control module:
controlling the identification data identifying the scanning device;
comparing the data with predefined data of authorized scanning devices;
authorizing the processing of the scanned unique product code if the device proves to be authorized;
wherein the method comprises the following steps implemented by the first processing unit by means of a registration module:
registering, in a first memory module, the unique product code scanned by the first scanning device if the device is authorized;
assigning values representative of a saleable product to the scanned unique product code;
storing the values representative of a saleable product in the first memory module, together with the respective unique product code;
wherein the method comprises the following steps implemented by the second scanning device:
scanning the unique product code on the product intended for sale;
connecting with the first processing unit;
wherein the method comprises the following steps implemented by the second processing unit associated with the second scanning device by means of a comparison module:
comparing the scanned unique product code with said registered codes representative of a saleable product and stored in said first memory module;
wherein the method comprises the following steps implemented by the second processing unit by means of a confirmation module:
sending to the second scanning device an authenticity confirmation signal based on a positive result of the comparison carried out by said comparison module.

23-24. (canceled)
